(19) United States
(12) Patent Application Publication
(10) Pub. No.: US 2008/0289581 A1
(43) Pub. Date: Nov. 27, 2008

(54) Sta-bowl pet dish

(76) Inventors: Frank Aruthur Cox, JR., Temperance, MI (US); Gloria Jean Cox, Temperance, MI (US)

Correspondence Address: Frank Cox, Jr., 6675 Summerfield Road, Temperance, MI, 48182, US

(21) Appl. No.: 12/151,175

(22) Filed: May 5, 2008

Related U.S. Application Data
(60) Provisional application No. 60/928,049, filed on May 7, 2007.

(51) Int. Cl. A01K 1/10; A01K 7/00; B65D 25/24

(52) U.S. Cl. 119/61.54; 119/72; 220/635

(57) ABSTRACT

The invention provides a stable feeding/watering dish for pets which is facilitated by suction cups positioned on the bottom or substructure of the dish.

### CROSS-REFERENCE TO RELATED APPLICATIONS

This application is related to and claims priority from U.S. Provisional Patent Application Ser. No. 60/928,049 filed on May 8, 2007.

### FIELD OF THE INVENTION

The present invention relates generally, but not limited to, feeding and watering bowls for pets. More particularly, the invention relates to the structure of the individual bowl, especially the outside bottom of the bowl covered or fashioned with small suction cups which proving the said bowl to be virtually unmovable by a pet.

### BACKGROUND OF THE INVENTION

Many types of bowls have been designed for the purpose of feeding and watering pets. A common problem with these bowls is that a pet can easily tip over or displace the bowl simply by slapping the bowl with its paw or by picking up the bowl in its mouth. Thus the spillage caused by the displacement of the bowl creates a mess and possible hazard.

A need exists, therefore, of creating a bowl that is designed to stay in place and not be moved by a pet. The present invention, as described below, fills this need by using suction cups on the bottom of the bowl to hold the bowl securely in place. These suction cups adhere to most surfaces and even proves resistance, by friction, in sliding on carpeted surfaces.

### BRIEF DESCRIPTION OF THE DRAWINGS

FIG. 1 is a perspective view of Sta-bowl Pet Dish of the present invention.

FIG. 2 is a side elevation view of the bowl of FIG. 1.

FIG. 3 is a close up view of the substructure of FIG. 1.

### DETAILED DESCRIPTION OF THE INVENTION

The present invention provides, but is not limited to, a pet feeding/watering bowl that is stable, virtually unmovable by pets, on clean, smooth, non-porous surfaces and the methods of using and making such bowls, that facilitate stability by means of suction cups on the substructure of the bowl. The invention is useful with any type of dish, but may find its greatest utility with rubber or plastic or aluminum pet dishes.

In one embodiment the invention provides a pet feeding/watering dish comprising, consisting essentially of, and consisting of a means for stabilizing a pet dish on a clean, smooth, non-porous surface.

Typically, pet dishes that are purchased by the consumer are designed to be placed on a household floor. When pets encounter these bowls, the bowls can easily be displaced by the pet simply by the pet slapping the bowl with its paw or by picking up the bowl in its mouth.

It is a discovery of the invention that stability of the dish can be facilitated by incorporating suction cups in the design of the substructure of the bowl

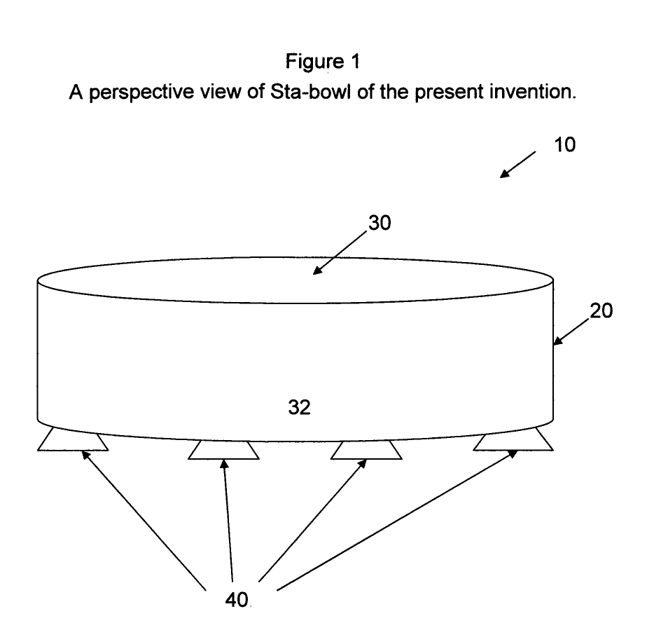

FIG. 1-3 illustrates the pet feeding/watering bowl, Sta-bowl Pet Dish, of the present invention In FIG. 1, there is shown the pet feeding/watering bowl, Sta-bowl Pet Dish, of the present invention denoted generally by the numeral 10 showing an outer wall 20, an inner wall 30, and suction cups 40 attached to the substructure of 10. The inner wall 30 further comprises a bottom wall 32 preferably extending substantially along a horizontal plane upon which is usually placed food, water or such. The outer wall 20 and inner wall 30 are preferably integrally formed as a one-piece structure from either aluminum or rubber or plastic.

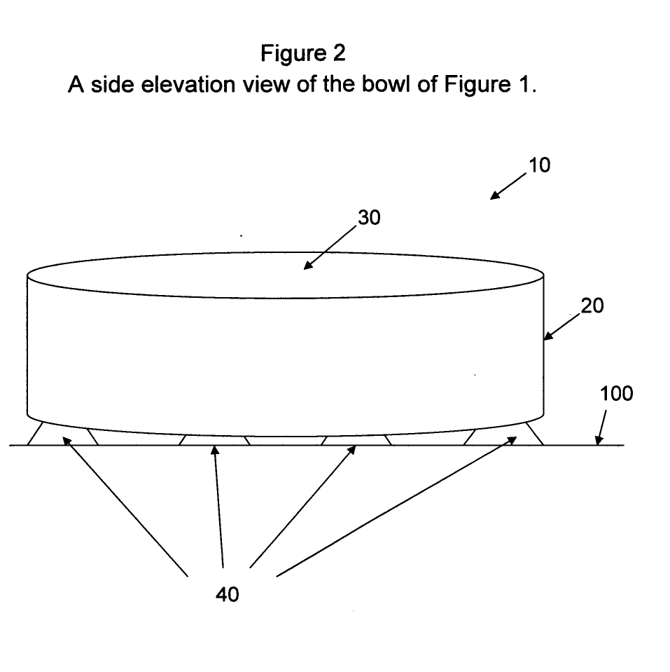

FIG. 2 illustrates a perspective view of a bowl 10 of the invention. Bowl 10 has an outer wall 20, an inner wall 30, and suction cups 40 attached to the substructure of 10. The suction cups 40 can be made of plastic or rubber. When the pet bowl of 10 is pressed down to a clean, smooth, non-porous surface 100, thus producing a downward pressure to the suction cups 40, the air pressure inside is drastically reduced and the relatively higher atmospheric pressure forces the cups to stick to the surface 100.

The suction cups 40 obviously will not stick to a carpeted surface, however, proves resistance, by friction, in sliding on carpeted surfaces.

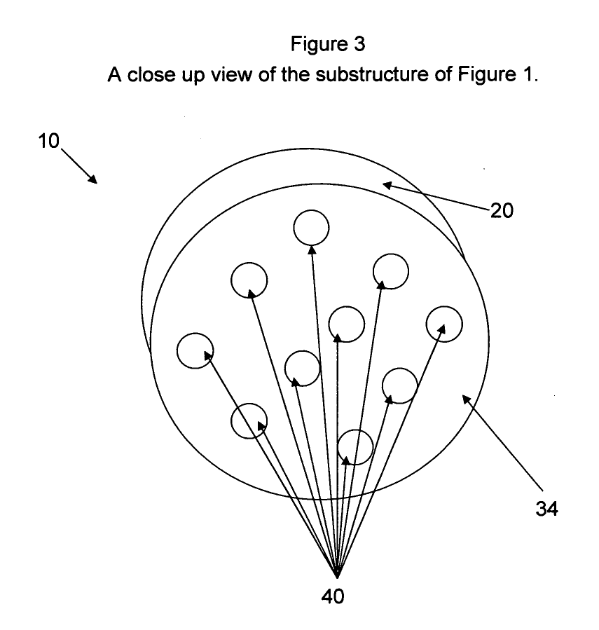

FIG. 3 illustrates a bottom plan view of bowl 10 of the invention. Bowl 10 has an outer wall 20, a substructure 34, and suction cups 40 which are attached or fashioned to the substructure of bowl 10.

A method of adhering suction cups 40 to the substructure 34 of the bowl 10, comprising two autonomous means therein, wherein the adhering means consisting of molding it as one unit with the bowl 10 or substructure 34 or separately producing a flat surface on one side with suction cups attached to the other side providing a means to adhere the aforementioned piece to the bowl 10 or substructure 34 in a separate operation.

The bowl of the invention preferably are used as feeding/watering bowls for pets made from plastic or rubber or aluminum. The substructure of the bowl is covered with suction cups made of rubber or plastic.

### Sta-Bowl Pet Dish

### REFERENCES SITED FROM U.S. PATENT DOCUMENTS

U.S. Pat. No. 2,813,509 A November 1957 Bruno 119/51.01
U.S. Pat. No. 3,722,476 A March 1973 Van Ness et al, 119/61
U.S. Pat. No. 3,776,193 A December 1973 Post, Sr.
U.S. Pat. No. 3,810,446 A May 1974 Kightlinger et al 119/61
U.S. Pat. No. 4,089,498 A May 1978 Woodruff 248/346.11
U.S. Pat. No. 4,428,325 A January 1984 Koch 119/61
U.S. Pat. No. 4,603,851 A August 1986 Russell 482/51
U.S. Pat. No. 4,721,063 A January 1988 Atchley 119/52.1
U.S. Pat. No. 4,886,016 A December 1989 Atchley
U.S. Pat. No. 4,905,629 A March 1990 Hand et al 119/61
U.S. Pat. No. 4,981,108 A January 1991 Faeroe 119/61
U.S. Pat. No. 4,986,433 A January 1991 Davis
U.S. Pat. No. 5,037,084 A August 1991 Flor 108/12
U.S. Pat. No. 5,169,023 A December 1992 Heiberg et al, 220/254.7
U.S. Pat. No. 5,392,948 A February 1995 McEntee 220/574
U.S. Pat. No. 5,423,452 A June 1995 Tardif 220/574
U.S. Pat. No. 5,546,894 A August 1996 St. Pierre
U.S. Pat. No. 5,560,732 A October 1996Kulp et al 116/63
U.S. Pat. No. 5,564,363 A October 1996 Soffici
U.S. Pat. No. 5,724,914 A March 1998 Nemeth
U.S. Pat. No. 5,743,210 A April 1998 Lampe 119/51.5
U.S. Pat. No. 5,813,638 A September 1998 Morris 220/574
U.S. Pat. No. 5,857,427 A January 1999 Kelley 119/61
U.S. Pat. No. 5,979,361 A November 1999 Willinger
U.S. Pat. No. 6,119,628 A September 2000 Lorenzana et al 119/77
U.S. Pat. No. 6,152,319 A November 200 Kamachi et al 220/592.2
U.S. Pat. No. 6,230,653 B1 May 2001 Tobin 119/72
U.S. Pat. No. 446,362 S August 2001 Choi et al D30/129
U.S. Pat. No. 6,330,956 B1 December 2001 Willinger 220/574
U.S. Pat. No. 6,516,747 B1 Feb. 11, 2003 Willinger

1. A pet feeding/watering bowl, comprising a means for stability of the bowl on select surfaces thereon, whereon the stabilization means consists of a mechanical deformation of the outside surface of the substructure of the bowl, incorporating suction cups.

2. The bowl of claim 1, wherein the stability of the bowl is a mechanical deformation of the bowl.

3. The bowl of claim 1, wherein the stability means is suction cups.

4. A pet bowl, comprising:
(a) a base comprising an encompassing sidewall and a bottom, the bottom having an inner surface, wherein the sidewall and bottom define a cavity suitable for housing water or food; and
(b) a substructure covered or fashioned with small suction cups in that when pressed against a clean, smooth, non-porous surface holds the bowl in place.

5. The bowl of claim 4, wherein the substructure is covered or fashioned with suction cups.

6. The bowl of claim 4, wherein the substructure is covered or fashioned with several small suction cups.

7. The bowl of claim 4, wherein the base is made of material that is less flexible than the material from which the suction cups are made.

8. The bowl of claim 4, wherein the base is made of material that may include, but is not limited to, stainless steel or ceramic or rubber or plastic.

9. A pet bowl, comprising:
(a) a base comprising an encompassing sidewall and a bottom, the bottom having an inner surface, wherein the sidewall and bottom define a cavity suitable for housing water or food; and
(b) a substructure covered or fashioned with small suction cups extending downward from the substructure.

10. The pet bowl of claim 9, wherein the suction cups are attached to the substructure of the bowl.

11. The pet bowl of claim 9, wherein the suction cups upon pressing them to a surface, the air pressure inside is drastically reduced and the relatively higher atmospheric pressure forces the cups to stick to the surface.

12. The suction cups of claim 9, wherein the suction cups are made of rubber or plastic.

13. A method of adhering suction cups to the substructure of the pet bowl, comprising two autonomous means therein, wherein the adhering means consisting of molding it as one unit with the bowl or separately producing a flat surface on one side with suction cups attached to the other side providing a means to adhere the aforementioned piece to the bowl in a separate operation.

14. The method of claim 13, wherein the adhering of suction cups means is a mechanical deformation of the bowl.

15. The method of claim 13, wherein the suction cups are rubber or plastic.
